(19) United States
(12) Patent Application Publication
(10) Pub. No.: US 2006/0027541 A1
(43) Pub. Date: Feb. 9, 2006

(54) Programmable non-contact fusion welding apparatus and method

(76) Inventors: Peter C. Sun, Rochester Hills, MI (US); Pei-Chung Wang, Troy, MI (US)

Correspondence Address: KATHRYN A MARRA;General Motors Corporation, Legal Staff, Mail Code 482-C23-B21, P.O. Box 300, Detroit, MI, 48265-3000, US

(21) Appl. No.: 10/910,004

(22) Filed: Aug. 3, 2004

(51) Int. Cl. B23K 26/24

(52) U.S. Cl. 219/121.63; 219/121.64; 219/161

(57) ABSTRACT

A non-contact fusion welding apparatus has a pair of programmable clamps carried on universally movable positioners. The positioners are programmed to move the clamps sequentially along a laser weld path so that the clamps, engage and support opposite surfaces of the pair of workpieces at respective selected locations during the weld process to insure intimate and continuous contact between the workpieces along the entire length of the laser weld site.

### TECHNICAL FIELD

This invention relates to non-contact fusion welding and, more particularly, to a workpiece clamping apparatus and method for insuring intimate and continuous contact between the workpieces during non-contact fusion welding.

### BACKGROUND OF THE INVENTION

Non-contact fusion welding techniques such as laser welding, electron beam welding, plasma welding and arc welding are known in the art for joining metal and polymer workpieces. In order for a non-contact fusion weld to be properly formed, the workpieces to be joined must be in continuous contact along the entire length of the weld. Any gaps between the workpieces can result in malformed pieces or a weld having insufficient strength. Previously devised clamps for non-contact fusion welding are sometimes inadequate for insuring continuous contact, since these clamps may only engage a portion of the workpiece at a location separate or apart from the weld site. As a result, the workpieces may not be adequately forced together to insure continuous contact during the welding process.

Thus, it is desirable to provide a clamping apparatus for non-contact fusion welding operations which insures intimate and continuous contact between the workpieces or parts along the entire length of the weld site. It is also desirable to provide a clamp for non-contact fusion welding which can be configured in a variety of shapes to conform to any desired weld pattern or part shape.

### SUMMARY OF THE INVENTION

The present invention provides non-contact fusion welding apparatus having a pair of programmable clamps carried by universally movable positioners. The positioners are programmed to move the clamps sequentially adjacent a weld path or sequentially adjacent selected weld locations so that the clamps, engage and support opposite surfaces of a stacked pair of workpieces during welding to insure intimate and continuous contact between the stacked workpieces along the entire length of the weld.

In an exemplary embodiment, the non-contact fusion welding apparatus employs a welding laser. However, other such non-contact welding devices such as an arc welder, a plasma welder or an electron beam welder may be substituted for the welding laser.

A first programmable positioner in the form of a programmable robot includes a base having a jointed arm carrying the welding laser and an upper clamping member (upper clamp). Alternatively, the robot may have a jointed arm carrying an upper clamping member and another jointed arm carrying a welding laser. The non-contact fusion welding apparatus further includes a suitable holding fixture or support adapted to carry a temporary structural assembly formed of stacked metal or polymer workpieces. The apparatus also includes a second programmable positioner located beneath the support.

The second positioner includes a base that is linearly movable along a rail extending about the length of the support. The base carries a positionable lower clamping member (lower clamp) adjustably supported by a plurality of control arms. The control arms and the base are adjustable by programmable controls to adjust the position of the base along the rail and the attitude and position of the lower clamp relative to the base.

A structural assembly comprising a pair of workpieces in temporary assembly with opposing surfaces in contact for laser welding at selected locations is carried by the support of the welding apparatus. The first and second positioners subsequently position the upper and lower clamps adjacent a first selected location so that the clamps engage opposite surfaces of the structural assembly to hold the workpieces together. The laser is then operated to form a laser weld at the first selected location adjacent the clamps.

After welding the first selected location, the clamps are repositioned adjacent subsequent selected locations. As the clamps engage the assembly at the subsequent locations, the laser is re-aimed at the respective locations to sequentially form welds at each of the selected locations. Once all of the locations are welded, the structural assembly is completed and removed from the support.

These and other features and advantages of the invention will be more fully understood from the following description of certain specific embodiments of the invention taken together with the accompanying drawings.

### BRIEF DESCRIPTION OF THE DRAWINGS

FIG. 1 is a schematic pictorial view of a non-contact fusion welding apparatus according to the invention; and

FIG. 2 is a similar view of an alternative embodiment of the non-contact fusion welding apparatus of FIG. 1.

### DESCRIPTION OF THE PREFERRED EMBODIMENT

Throughout the following description and drawings, like reference numerals refer to like components shown in the various figures of the drawing.

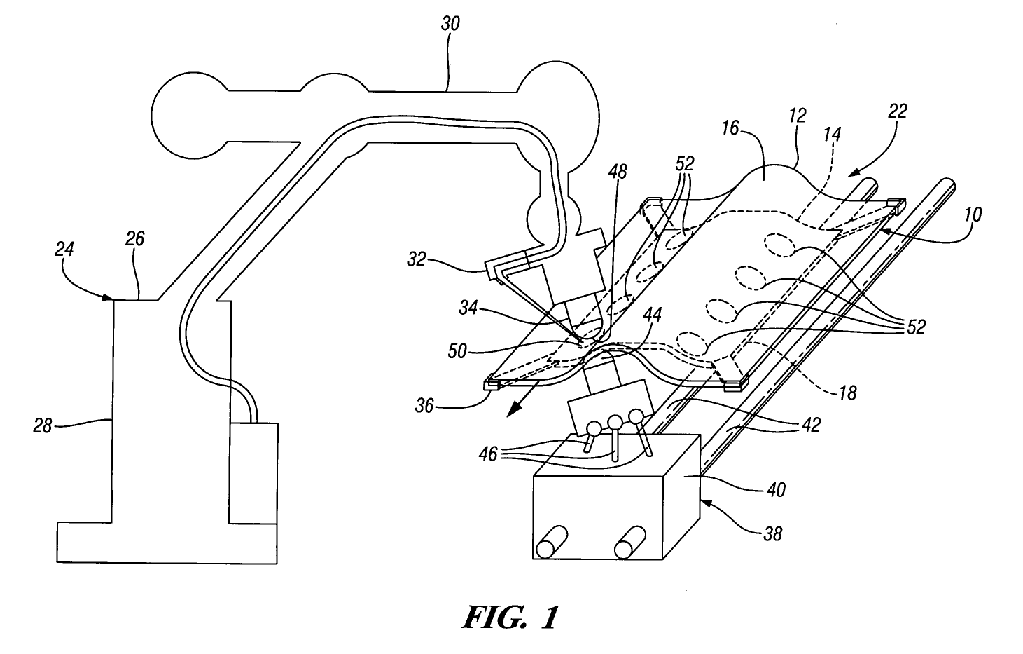

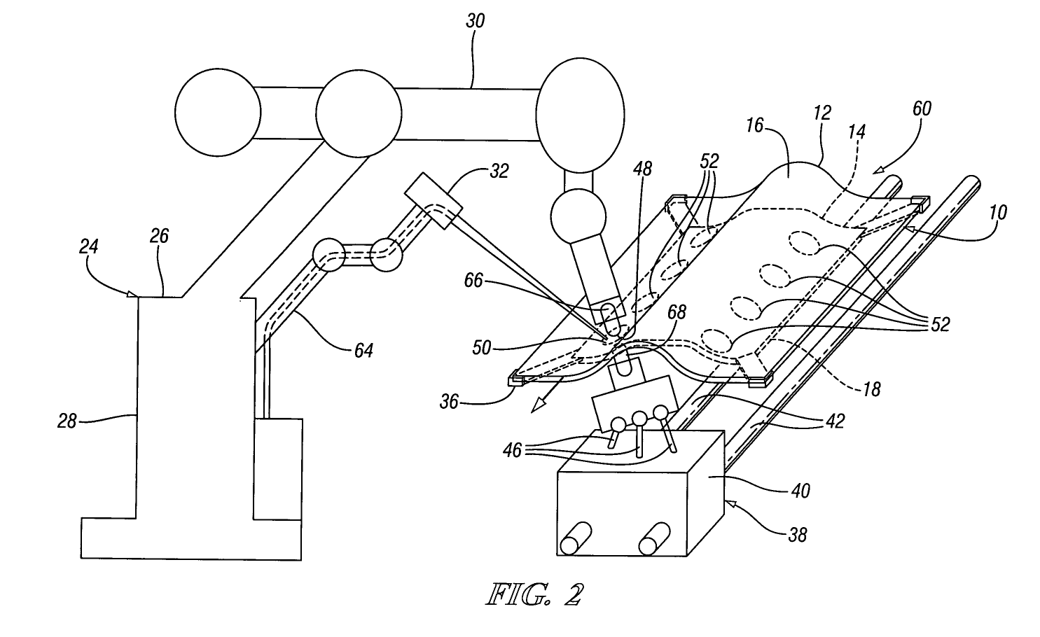

Referring to FIGS. 1 and 2 of the drawings, numeral 10 generally indicates a structural assembly in the form of a tunnel undershield and tunneled floor pan of a vehicle. The structural assembly includes first and second stacked metal or polymer workpieces 12, 14 and the assembly has upper and lower surfaces 16, 18.

FIG. 1 shows an exemplary embodiment of a non-contact fusion welding apparatus 22. The apparatus 22 includes a first positioner 24 in the form of a robot 26. If appropriate, any other suitable form of programmable positioner may be substituted for the robot 26 within the scope of the invention. The robot 26 includes a base 28 and a jointed arm 30 carrying a welding laser 32 and an upper clamping member (upper clamp) 34.

The non-contact fusion welding apparatus 22 further includes a suitable holding fixture or support 36 adapted to carry the structural assembly 10. The apparatus 22 also includes a programmable positioner 38 located beneath the support. The positioner 38 includes a base 40 that is linearly movable along a rail 42 extending along the length of the support 36. The base 40 carries a positionable lower clamping member (lower clamp) 44 adjustably supported by a plurality of control arms 46. The control arms 46 and the base 40 are adjustable by programmable controls, not shown, to adjust the position of the base along the rail 40 and the attitude and position of the lower clamp 44 relative to the base.

In operation, the spatial coordinates of the structural assembly 10 are programmed into the positioners 24, 38. Structural assembly 10, comprising workpieces 12, 14 in temporary assembly with opposing surfaces in contact for laser welding at selected-locations, is placed onto the support 36 of the welding apparatus 22. The first and second positioners 24, 38 subsequently position the upper and lower clamps 34, 44 adjacent a first selected location 48 so that the clamps engage opposite surfaces 16, 18 of the structural assembly 10. The laser 32 is then aimed toward the first selected location 48 and energized to form a laser weld at the first selected location. If desired, the laser may form a seam weld for a distance adjacent the clamps to form a seam weld at the selected location.

After a weld is created at the first selected location, the laser 32 and the clamps 34, 44 may be sequentially repositioned at subsequent selected locations 52 to allow the laser 32 to form multiple spot or seam welds 50 at the subsequent locations. After all of the selected locations 52 are welded, the structural assembly is removed from the support.

FIG. 2 shows an alternative welding apparatus 60 similar to welding apparatus 22 where the welding laser 32 is removed from the jointed arm 30 and alternatively carried by a third positioner, such as jointed positioning arm 64 extending from the base 28 of the robot 26. In addition, the upper and lower clamps 34, 44 are replaced with upper and lower roller clamps (clamping members) 66, 68 adapted to be rolled along the surface of the structural assembly 10.

In operation, welding apparatus 60 operates similarly to welding apparatus 22 in that the upper and lower roller clamps 66, 68 are positioned oppositely at selected locations 52 of a structural assembly 10 to provide clamping force holding together the workpieces 12, 14 to insure a high quality weld. Positioning arm 64 aims the welding laser 32 at the selected location 52, which is clamped by the roller clamps 66, 68. The laser is then energized to form a weld 50 at the selected location.

As the laser forms the weld 50, the laser 32 and the roller clamps 66, 68 may be moved along their respective surfaces 16, 18, from the selected location 52, to form a seam weld 50 connecting the workpieces 12, 14. As the clamps are moved along their respective surfaces they maintain clamping pressure to insure contact between the workpieces 12, 14. As needed, the positioners 24, 38 reposition the roller clamps 66, 68 to maintain optimal clamping pressure and contact along the contours of the structural assembly 10. As a result, a high quality laser seam weld 50 can be formed between the workpieces 12, 14.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. Apparatus for automatic non-contact fusion welding of workpieces, the apparatus comprising:
a support for holding a pair of workpieces in a temporary assembly with opposing surfaces in contact for laser welding at selected locations;
first and second clamping members selectively engagable with opposite surfaces of the assembly adjacent the selected locations for locally clamping and supporting the workpieces;
a first positioner programmable to move the first clamping member to sequentially engage one of the workpieces adjacent each of the selected locations on one surface of the assembly;
a second positioner programmable to move the second clamping member to sequentially engage another of the workpieces adjacent each of the selected locations on an opposite surface of the assembly for laser welding of the assembly at said locations; and
a non-contact fusion welding device operable to sequentially form welds at the selected locations while the first and second clamping members engage the workpieces adjacent the selected locations.

2. An apparatus as in claim 1 wherein the clamping members are rollers operable to be rolled along the surface of the workpieces.

3. An apparatus as in claim 1 wherein the clamping members are heads selectively movable for clamping the workpieces at the selected locations.

4. An apparatus as in claim 1 wherein the positioners are programmable robots.

5. An apparatus as in claim 1 wherein the non-contact fusion welding device is carried by the first positioner.

6. An apparatus as in claim 1 wherein the non-contact fusion welding device is mounted on a separate positioner.

7. An apparatus as in claim 1 wherein the non-contact fusion welding device is a laser.

8. A method for automatic non-contact fusion welding of workpieces, the method comprising:
combining a pair of workpieces into a temporary assembly having at least selected locations in contact for non-contact fusion welding the workpieces together;
automatically actuating a first programmable mechanism to move a first clamping member into engagement with one surface of the assembly adjacent the selected locations in sequence;
automatically actuating a second programmable mechanism to move a second clamping member in engagement with an opposite surface of the assembly adjacent the selected location in sequence; and
welding with a non-contact fusion welding device during engagement of the workpieces by both of the clamping members adjacent each of the selected locations to sequentially weld the workpieces together at the selected locations.

9. A method as in claim 8 wherein the programmable mechanisms are positioners.

10. A method as in claim 9 wherein at least one of the programmable mechanisms is a robot.

11. A method as in claim 8 wherein the clamping members are rollers operable to be rolled along the surfaces of the workpieces.

12. An apparatus as in claim 8 wherein the clamping members are heads selectively movable for clamping and engaging the workpieces.

13. A method as in claim 8 wherein the non-contact fusion welding device is a laser.
